(19) United States
(12) Patent Application Publication
(10) Pub. No.: US 2017/0242959 A1
(43) Pub. Date: Aug. 24, 2017

(54) METHOD AND SYSTEM FOR QUANTIFYING THE LIKELIHOOD THAT A GENE IS CASUALLY LINKED TO A DISEASE

(71) Applicant: UCB BIOPHARMA SPRL, Brussels (BE)

(72) Inventors: Matthew PAGE, Windsor (GB); Patrice GODARD, Braine-l'Alleud (BE)

(21) Appl. No.: 15/052,807

(22) Filed: Feb. 24, 2016

(51) Int. Cl. G06F 19/18

(52) U.S. Cl. CPC G06F 19/18

(57) ABSTRACT

A computer program product, disposed on a non-transitory computer readable media, for analyzing a biological relevance of a candidate gene to a human phenotype is provided. The product includes computer executable process steps operable to control a computer to receive an input phenotype comprised of a plurality of input human traits and at least one input candidate gene; identify a plurality of disease-linked genes by querying disease-linked gene data and identifying genes causally linked to at least one disease; provide values of a semantic similarity metric for a identified gene set with respect to the input phenotype based on a comparison of human traits linked to each gene of the identified gene set and the input human traits, the identified gene set including genes mechanistically related to the input candidate gene that are included in the identified disease-linked genes; and output a statistical measure indicating whether the values of the semantic similarity metric of the genes of the identified gene set with respect to the input phenotype are greater than the values of the semantic similarity metric of others of the identified disease-linked genes with respect to the input phenotype by a statistically significant amount.

The present disclosure relates generally to genetic diseases and more specifically to a method and system for identifying disease causing genes.

### BACKGROUND

Rare human diseases are principally genetic in origin, exhibit Mendelian inheritance and are present in infancy as life threatening or chronically debilitating conditions. Rare Mendelian diseases individually affect only a small fraction of the global population but together total over 7000 different diseases with a cumulative prevalence estimated to be as many as 82 per 1000 live births. See Yang et al., “Clinical whole-exome sequencing for the diagnosis of mendelian disorders,” N. Engl. J. Med. 369, 1502-1511 (2013). Rare genetic diseases are a significant socio-economic burden both in terms of prevalence and the long term, palliative healthcare that is often required.

Every individual contains approximately 100 deleterious, loss-of-function (LoF) variants in their genome. See MacArthur, et al, “A systematic survey of loss-of-function variants in human protein-coding genes,” Science 335, 823-828 (2012). Of these, 1-2 variants arise de novo and may lead to sporadic disease. See Veltman et al., “De novo mutations in human genetic disease,” Nat. Rev. Genet. 13, 565-575 (2012). In Mendelian disease, with respect to cases that have frustrated classical diagnostic methods, de novo variants are the most frequently identified causal category.

Numerous methods exist to prioritize or filter candidate causal variants based on control population frequency, the likely impact of the variant on protein function and gene-level measures of mutational intolerance, as described in Petrovski et al., “Genic intolerance to functional variation and the interpretation of personal genomes,” PLoS Genet. 9, e1003709 (2013), and haploinsufficiency, as described in Huang et al., “Characterising and predicting haploinsufficiency in the human genome,” PLoS Genet. 6, e1001154 (2010). Nevertheless, the final diagnostic coup de grace often comes down to whether other variants in the same gene are known to cause a similar phenotype. Such an assessment requires considerable clinical experience and does not lend itself to a quantitative assessment of confidence. See Petrovski et al., “Phenomics and the interpretation of personal genomes,” Sci. Transl. Med. 6, 254fs35 (2014).

Several current methods for candidate prioritization assess semantic similarity to known diseases as a way to evaluate the biological relevance of a putative causal gene to the disease of interest. Such approaches are described in Kohler et al., “Clinical Diagnostics in Human Genetics with Semantic Similarity Searches in Ontologies,” Am. J. Hum. Genet. 85, 457-464 (2009); Zemojtel et al., “Effective diagnosis of genetic disease by computational phenotype analysis of the disease-associated genome,” Sci. Transl. Med. 6, 252ra123 (2014); and Smedley et al. “Walking the interactome for candidate prioritization in exome sequencing studies of Mendelian diseases,” Bioinformatics 30, 3215-3222 (2014). However, by their very nature such approaches are critically restricted to the diagnosis of known human diseases, including identification of new variants for known disease genes and accommodating limited phenotype expansions. To extend the scope of application beyond the human disease associated genome, PhenoDigm incorporates phenotypes from mouse genetic models into a semantic similarity methodology. See Smedley et al., “PhenoDigm: analyzing curated annotations to associate animal models with human diseases,” Database J. Biol. Databases Curation 2013, bat025 (2013). This is enabled by cross-referencing the Human Phenotype Ontology (HPO) and the Mammalian Phenotype Ontology. See Smith et al., “The Mammalian Phenotype Ontology: enabling robust annotation and comparative analysis,” Wiley Interdiscip. Rev. Syst. Biol. Med. 1, 390-399 (2009).

### SUMMARY OF THE INVENTION

A computer program product, disposed on a non-transitory computer readable media, for analyzing a biological relevance of a candidate gene to a human phenotype is provided. The product includes computer executable process steps operable to control a computer to receive an input phenotype comprised of a plurality of input human traits and at least one input candidate gene; identify a plurality of disease-linked genes by querying disease-linked gene data and identifying genes causally linked to at least one disease; provide values of a semantic similarity metric for a identified gene set with respect to the input phenotype based on a comparison of human traits linked to each gene of the identified gene set and the input human traits, the identified gene set including genes mechanistically related to the input candidate gene that are included in the identified disease-linked genes; and output a statistical measure indicating whether the values of the semantic similarity metric of the genes of the identified gene set with respect to the input phenotype are greater than the values of the semantic similarity metric of others of the identified disease-linked genes with respect to the input phenotype by a statistically significant amount.

A method of delivering a file containing the computer program product is also provided. The method includes providing the file over the interne for download.

A computer implemented method for analyzing a biological relevance of a candidate gene to a human phenotype is also provided. The method is implemented on a computer including a processor and a memory and includes receiving an input phenotype comprised of a plurality of input human traits and at least one input candidate gene; identifying a plurality of disease-linked genes by querying disease-linked gene data and identifying genes causally linked to at least one disease; providing values of a semantic similarity metric for a identified gene set with respect to the input phenotype based on a comparison of human traits linked to each gene of the identified gene set and the input human traits, the identified gene set including genes mechanistically related to the input candidate gene that are included in the identified disease-linked genes; and outputting a statistical measure indicating whether the values of the semantic similarity metric of the genes of the identified gene set with respect to the input phenotype are greater than the values of the semantic similarity metric of others of the identified disease-linked genes with respect to the input phenotype by a statistically significant amount.

A computer configured for analyzing a biological relevance of a candidate gene to a human phenotype is also provided. The computer includes a data structure including a trait-gene link data record and a mechanistically related genes data record, the trait-gene link data record including trait-gene link data directly linking human traits to genes, the mechanistically related genes data record including mechanistic links between genes; and a processor configured to control the computer to receive an input phenotype comprised of a plurality of input human traits and at least one input candidate gene; identify a plurality of disease-linked genes by querying disease-linked gene data and identifying genes causally linked to at least one disease; provide values of a semantic similarity metric for a identified gene set with respect to the input phenotype based on a comparison of human traits linked to each gene of the identified gene set and the input human traits, the identified gene set including genes mechanistically related to the input candidate gene that are included in the identified disease-linked genes; and output a statistical measure indicating whether the values of the semantic similarity metric of the genes of the identified gene set with respect to the input phenotype are greater than the values of the semantic similarity metric of others of the identified disease-linked genes with respect to the input phenotype by a statistically significant amount.

### BRIEF DESCRIPTION OF THE DRAWINGS

The present invention is described below by reference to the following drawings, in which:

FIG. 1 schematically illustrates an embodiment of a computer for identifying disease causing genes in accordance with an embodiment of the present invention;

FIG. 2 illustrates a flow chart of a method in accordance with an embodiment of the present invention of creating a data structure;

FIG. 3 illustrates a flow chart of a method executable by a computer program product for analyzing a biological relevance of a candidate gene to a human phenotype in accordance with an embodiment of the present invention;

FIG. 4 illustrates an example of a graphical user interface on a display of the computer including a phenotype input section configured for receiving human trait inputs a candidate gene input;

FIG. 5 illustrates a visualization of a basic example of trait comparisons;

FIG. 6 illustrates visualization of a basic example of a comparison of a phenotype and a gene;

FIG. 7 illustrates an example mechanistic links visualization illustrating a biological pathway;

FIG. 8 illustrates a visualization of results of a Mann-Whitney U test comparing symmetric semantic similarity scores of mechanistically related genes and all other disease linked-genes with respect to an input phenotype and a visualization of a biological network;

FIG. 9 illustrates a visualization of exemplary symmetric semantic similarity information; and

FIG. 10 illustrates another visualization of exemplary symmetric semantic similarity information.

### DETAILED DESCRIPTION

A genes biological function is not the consequence of the encoded product working in isolation but rather the culmination of a highly coordinated sequence of interactions with other molecules that cooperate as a functional module. Such functional modules can be considered as coherent biological pathways or processes. If molecules work together to perform a particular biological function, then it follows that genetic disruption of different members of the same module will result in a similar phenotype; functional modules may display a close consensus phenotype. This raises the possibility of an indirect phenotype-based method for variant prioritization that assesses the consensus phenotype similarity across a community of interacting proteins in a way that does not require an existing diagnostic hypothesis with a corresponding set of known causal genes and hence does not suffer from the resultant limitation in scope.

Mendelian diseases are often the physical manifestation of the causal gene mutation exerting its influence in different developmental and anatomical contexts. As a result Mendelian diseases tend to be phenotypically diverse which, can prove challenging when attempting to assess the phenotypic match of a disease to the known biological function of a gene. A network-driven, phenotype-based approach can aid in this deconvolution by ascribing sets of traits to different molecular interactions, so-called edgotypes as described in Sahni et al., “Edgotype: a fundamental link between genotype and phenotype,” Curr. Opin. Genet. Dev. 23, 649-657 (2013), thereby elaborating the mechanism of action of the causal variant.

The present disclosure provides an indirect phenotype-based method for candidate gene variant prioritization that quantifies the consensus similarity of genetic disorders linked to the mechanism of a putative disease causing gene. The approach dramatically expands the scope of application of semantic phenotype similarity methods; to allow support for the discovery of novel disease-linked genes as well as the diagnosis of existing Mendelian disorders and naturally lends itself to the mechanistic deconvolution of diverse phenotypes.

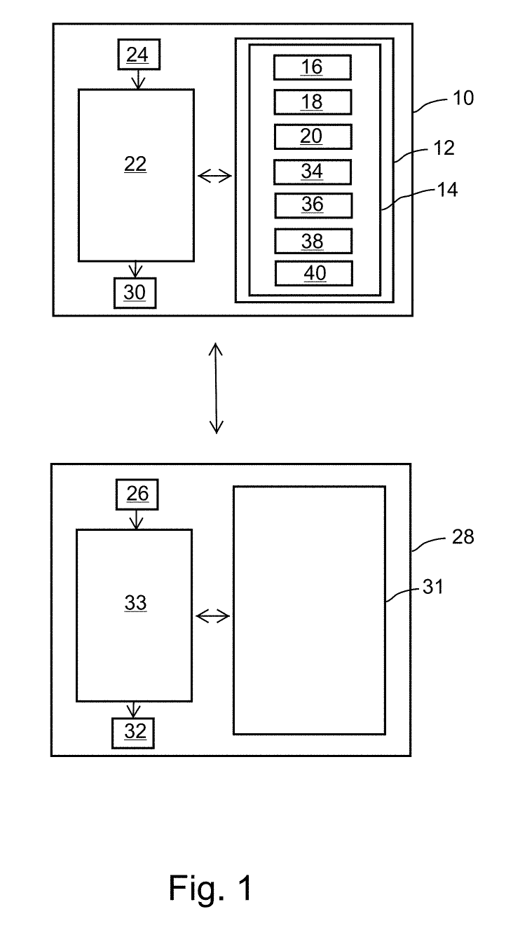

FIG. 1 schematically shows an embodiment of a computer 10 for analyzing a biological relevance of a candidate gene to a human phenotype in accordance with an embodiment of the present invention. Computer 10 includes a memory 12, which stores a data structure 14 including data records 16, 18, 20 including information compiled from a plurality of data sources, which in a preferred embodiment, are prepopulated with data before being used in the method 150 described below. Data structure 14 includes a trait-gene link data record 16, a mechanistically related genes data record 18 and information content (IC) data record 20.

Computer 10 further includes a processor 22 configured to access the data in data records 16, 18, 20 and perform calculations in accordance with the method 150 described below in response to inputs from a user via an input device 24 of computer 10 or a input device 26 a remote computer 28 to determine a statistical measure of a significance of a candidate gene with respect to an input phenotype and display the statistical measure to a user on an output device 30, e.g., a display, of the computer 10 or an output device 32, e.g., a display, of remote computer 28. Input devices 24, 26 may each be at least one of a keyboard, a mouse or a touchscreen. In some embodiments of the present invention a computer program product including data structure 14 may be delivered as a file containing the computer program product by providing the file over the internet for download onto a memory 31 of remote computer 28 such that the computer program product can instruct a processor 33 of remote computer 28 to carry out the method 150 described below.

Trait-gene link data record 16 stores trait-gene link data. In a preferred embodiment, the trait-gene link data includes trait data comprised of standardized human trait labels and trait-gene link data comprised the standardized human trait labels directly linked to known disease-linked genes. All known Mendelian disease genes are annotated with standardized human trait labels. More specifically, in this embodiment, the standardized human trait labels are Human Phenotype (HP) terms from the Human Phenotype Ontology (HPO) and associated HPO database according to the genetic disease or diseases the gene is known to cause, as described in Köhler et al., “The Human Phenotype Ontology project: linking molecular biology and disease through phenotype data,” Nucleic Acids Res. 42, D966-D974 (2014). HP terms provide a controlled vocabulary for formally describing human traits, which compose human phenotypes, systematically for all human Mendelian diseases. In this embodiment, only human phenotype (HP) terms descended from the “Phenotypic abnormality” (HP:0000118) branch of the HPO are provided in the trait-gene link database. The phenotype annotation resource provided by the HPO is used in this embodiment to provide HP terms assigned to each disease found in the Online Mendelian Inheritance in Man (OMIM). In an alternative embodiment, the standardized human trait labels may be terms from Medical Subject Headings (MeSH), which is the NLM controlled vocabulary thesaurus used for indexing articles for PubMed.

Mechanistically related genes data record 18 stores mechanistically related genes data identifying mechanistic links between genes. The mechanistically related genes data includes for each respective gene in mechanistically related genes data record 18, all of the genes that are mechanistically related to the respective gene. In response to a query of the mechanistically related genes data for at least one input candidate gene, all genes that are mechanically related to the input candidate gene are retrieved by processor 22. The genes include known disease-linked genes, which are genes that are known to be casually linked to at least one disease, and genes that are not known to be linked any disease. An aim of the method is to compare a phenotype of interest with Mendelian diseases caused by a set of genes mechanistically related to a candidate causal gene. The candidate causal gene can advantageously be a known disease-linked gene or a gene that is not known to be linked any disease. The ability to analyze a candidate causal gene that is not known to be linked to any disease allows an increased number of genes to be analyzed in comparison with conventional techniques in which only known disease-linked genes may be used as candidate casual genes. Different knowledge resources for identifying candidate-related genes can be considered as different approaches for sampling molecular mechanisms. In this embodiment, genes mechanistically related to the known disease-linked genes include genes implicated in common molecular mechanisms and/or genes related in terms of protein interactions. Genes implicated in common molecular mechanisms are genes that belong to the same pathway. Gene related in terms of protein interactions are genes that encode protein products that are interaction partners of the encoded protein product of the gene of interest. In other words, mechanistically related genes are defined in terms of the protein products the genes encode. Genes encode protein products that either physically interact (i.e., are direct neighbors) or take part in a coordinated series of molecular events to fulfil a particular function (i.e., are members of the same pathway).

Two gene pathway databases are used to identify genes implicated in common molecular mechanisms: Reactome and Thomson-Reuters' MetaBase. Reactome, as described in Croft et al., “The Reactome pathway knowledgebase,” Nucleic Acids Res. 42, D472-D477 (2014), is a free, open-source, curated and peer reviewed pathway database. Version v52 may be used to associate 7580 human genes to 1345 individual pathways. MetaBase (http://thomsonreuters.com/metabase/) is a comprehensive manually curated database of mammalian biology and medicinal chemistry data. Version 6.20.66604, which includes 6978 human genes within 1465 pathways, may be used.

To identify genes related in terms of protein interactions, two biological network databases are used: the STRING database and once again Metabase. STRING, as described in Jensen et al., “STRING 8—a global view on proteins and their functional interactions in 630 organisms,” Nucleic Acids Res. 37, D412-D416 (2009), is a database of known and computationally predicted protein interactions. Interactions include both direct (physical) and indirect (functional) links. An example embodiment involves identifying 1249080 direct interactions involving 17114 human genes within STRING version 10. STRING also provides a measure of confidence for each interaction as a score ranging from 0 to 1000. In the following analyses, either the whole STRING network or only a high quality (HQ) subnetwork involving interactions with a score greater than or equal to 0.5 (507298 interactions between 13712 genes) are considered. The score may be calculated using the approach described in von Mering et al., “STRING: known and predicted protein-protein associations, integrated and transferred across organisms,” Nucleic Acids Res. 33, D433-D437 (2005). Additionally, 862,660 interactions, involving 23,136 genes, are extracted from MetaBase. Among these interactions, 238171 (involving 17,265 genes) are assigned a high trust and form the MetaBase high quality (HQ) subnetwork.

Data structure 14 also includes a plurality of further data records 34, 36, 38, 40 that are described in further detail below with respect to method 150. In a preferred embodiment, data records 34, 36, 38, 40 are populated with data during the implementation of method 150. Data structure 14 also includes an equations data record 42 that stores equations (1) to (5) for use by processor 22 in carrying out method 150.

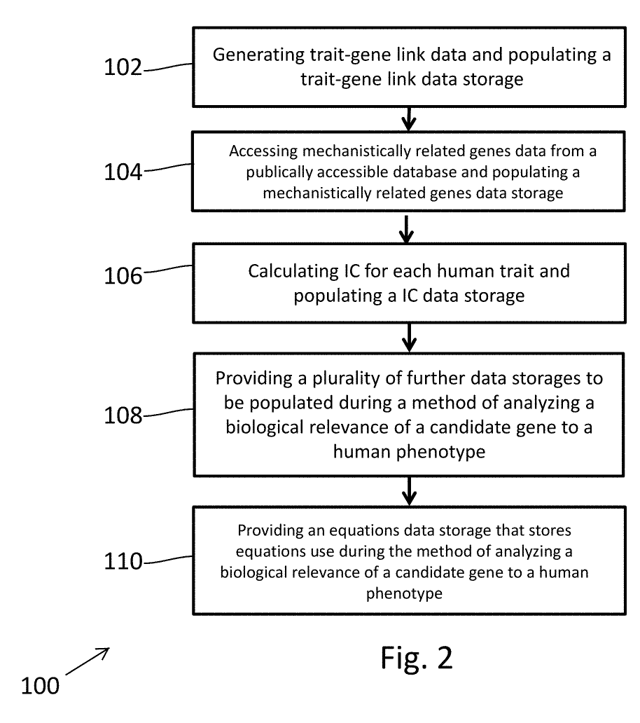

FIG. 2 shows a flow chart of a method 100 in accordance with an embodiment of the present invention of creating data structure 14, which may be a database or an R data object that is stored on a computer readable medium in accordance with an object of the present invention. Method 100 includes a step 102 of generating trait-gene link data and populating trait-gene link data record 16 with the trait gene data.

Step 102 includes a first substep of accessing gene-disease link data. The disease-gene association data includes causal links between diseases and known disease-linked genes. In a preferred embodiment, the clinVar database, as described in Landrum et al., “ClinVar: public archive of relationships among sequence variation and human phenotype,” Nucleic Acids Res. 42, D980-D985 (2014), is used to identify genes causally linked to Mendelian diseases. In this embodiment, as described in Maglott et al., “Entrez Gene: gene-centered information at NCBI,” Nucleic Acids Res. 39, D52-D57 (2011), the causally linked genes are identified using Entrez Gene identifiers. The disease may be limited to those reported within OMIM and linked variants with a pathogenic clinical status and one of the following origins: germline, de novo, inherited, maternal, paternal, biparental or uniparental.

Step 102 also includes a second substep of accessing disease-trait link data. The disease-trait link data includes known links between standardized human trait labels and disease diseases. In a preferred embodiment, the disease-trait link data is obtained from the HPO database.

Step 102, after first and second substeps, which may be performed in any order with respect to each other, next includes at a third substep of processing the gene-disease link data and the disease-trait link data to link standardized human trait labels to genes based on the gene-disease link data and the disease-trait link data. More specifically, each standardized trait is linked to genes that are linked to the disease, as accessed in the first substep, to which the standardized trait is linked, as accessed in step the second substep. Accordingly, the diseases act as the intermediaries that determine whether a standardized trait and a gene are linked. As noted above, in this embodiment, gene-disease links are identified using ClinVar pathogenic variants with one of the following origins: germline, de novo, inherited, maternal, paternal, biparental or uniparental. In total, 3,194 genes are linked to 3,675 OMIM diseases (4,569 gene-disease links). Links between human phenotypes and OMIM diseases are directly taken from the HPO database. In total, 5,604 HP terms are linked to 3,656 OMIM diseases (55,311 trait-disease links). These two links tables are joined in order to identify gene-trait links according to OMIM disease identifiers. If one gene is linked to several diseases it is, in turn, linked to the non-redundant list of HP terms associated to at least one of the diseases. In total, 3,181 genes are associated to 5,604 HP terms (67,989 gene-trait links). Accordingly, 67,989 trait-gene links in total are generated, which are stored in the trait-gene link database for example as a trait-gene table or matrix that is accessible by a processor.

In other words, step 102 includes commanding a computer to execute scripts to download the gene-disease link data and the disease-trait link data, which both are in the public domain and publicly accessible via the internet, and parse the gene-disease link data and the disease-trait link data to populate trait-gene link data record 16 in data structure 14.

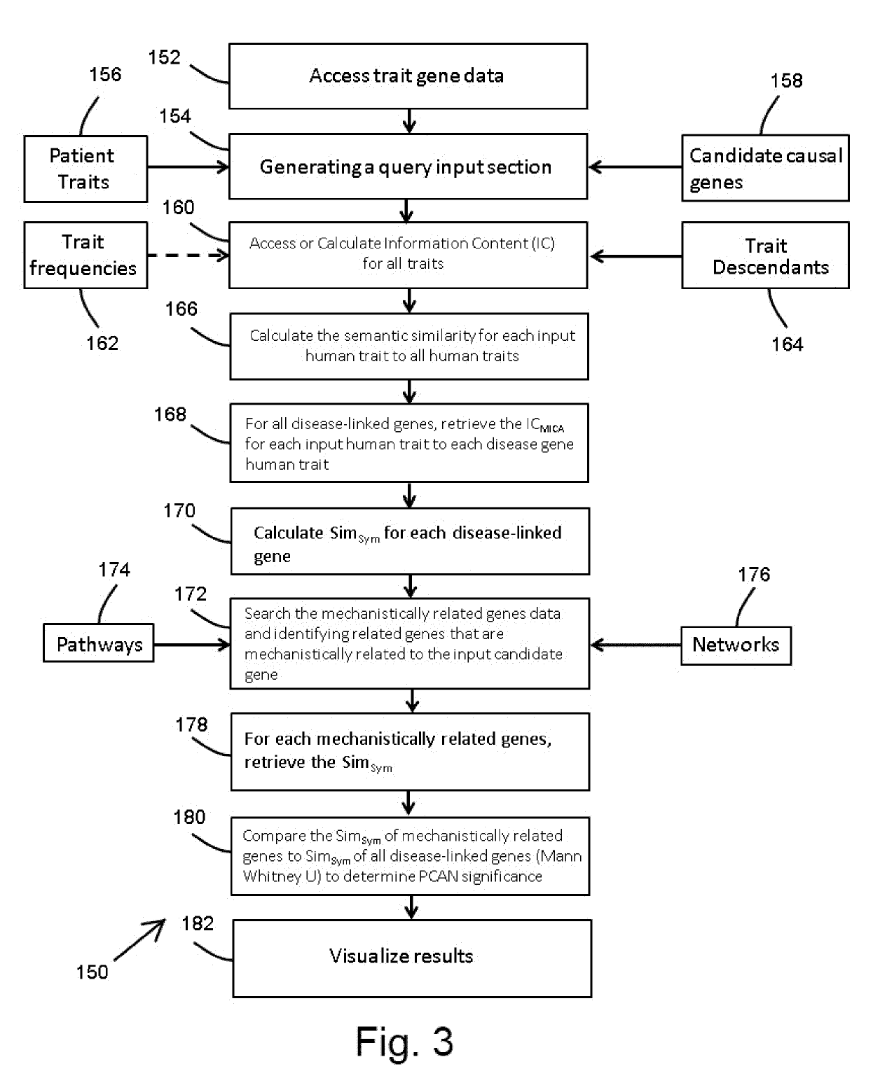

Method 100 also includes a step 104 of accessing mechanistically related genes data from a publically accessible database, such as for example at least one of the gene pathway databases and biological network databases, parsing the mechanistically related genes data to populate mechanistically related genes data record 18 in data structure 14. More specifically, the computer may execute scripts to download the mechanistically related genes data, which may be in the public domain and publicly accessible via the internet, and parse the mechanistically related genes data to populate mechanistically related genes data record 18 in data structure 14. In other embodiments, the populating of mechanistically related genes data record 18 may be omitted from method 100 and, as described below, mechanistically related genes data record 18 may be populated during method 150 described below with respect to FIG. 3 in response to inputs specified by the user.

Method 100 also include step 106 of calculating an information content (IC) for each of the HP terms from the HPO database, i.e., all of the HP terms in the trait-gene link database, is calculated using the IC approach as described in Cover et al., Elements of Information Theory (Wiley, 1991). See also, Köhler et al., (2009) and Resnik, P., “Using information content to evaluate semantic similarity in a taxonomy,” Proc. 14th Int. Jt. Conf. Artif. Intell. 448-453 (1995). The IC values are calculated for each HP term by a computer and are then stored in IC data record 20 in data structure 14. The IC is defined as the negative natural logarithm of the frequency of a term. The frequency of a term is defined as the proportion of objects that are annotated by the term or any of its descendent terms. The IC is thus defined using the following equation (1):

$${IC}_{p} = - ln ( \frac{\vert p \vert}{\vert root \vert} ) \qquad ( 1 )$$

where:

|p| is the number of genes directly linked to the HP term or one of its descendants; and

root is the Phenotypic abnormality term (HP:0000118), i.e., the total number of genes in the HPO database, which in this example is 3181 human genes.

In this embodiment, the IC of a HP term is defined on the basis of its frequency within the HPO database. For example, for “Short stature” (HP:0004322), this HP term and its decedent terms HP:0000839, HP:0003498, HP:0003502, HP:0003508, HP:0003510, HP:0003521, HP:0003561, HP:0004991, HP:0005026, HP:0005069, HP:0008845, HP:0008848, HP:0008857, HP:0008873, HP:0008890, HP:0008905, HP:0008909, HP:0008921, HP:0008922, HP:0008929, HP:0011404, HP:0011405, HP:0011406, HP:0012106, HP:0004322 are together annotated to 553 unique genes, so the IC is 1.749593 (553/3181).

In other embodiments, a frequency different than that described above can be used to calculate the information content. So rather than the number of genes linked to an HP term, the number of diseases that display a particular HP term may be used. Because multiple genes can cause the same disease, the derived ICs calculated based on the number of genes linked to an HP term may differ from the number of diseases that display a particular HP. In such embodiments, the creation of IC data record 20 may be modified to calculate the ICs as a function of the number of diseases that display a particular HP. In other embodiments, the creation of IC data record 20 may be omitted from method 100 and the IC may be calculated in response to inputs specified by the user and IC data record 20 may be populated during method 150 as described below with respect to FIG. 3 in response to inputs specified by the user.

A further step 108 includes providing data structure 14 with a plurality of further data records 34, 36, 38, 40 that are described in further detail below with respect to method 150, which are configured for being are populated with data during the implementation of method 150. Method 100 may also include a step 110 of providing data structure 14 with an equations data record 42 that stores equations (1) to (5), which are described in detail below.

In other alternative embodiments, instead of creating data structure 14, in response to the user inputs, the computer readable medium may access information from publicly available databases and generate disease-gene link data, the trait-gene link data and the mechanistically related genes data in real time in response to user inputs.

FIG. 3 shows a flow chart of a method 150 for analyzing a biological relevance of a candidate gene to a human phenotype executable by a computer program product in accordance with an embodiment of the present invention. The computer program product is disposed on a non-transitory computer readable media which have stored thereon computer executable process steps operable to control a computer(s), for example processor 22 of computer 10, to implement method 150. In a preferred embodiment of the present invention, the computer program product includes data structure 14. In one embodiment of the present invention, the computer program product is an “R” package. (R is a free software language and environment for statistical computing and graphics, www.r-project.org). A file containing the computer program product may be delivered to users by providing the file over the internet for download. Strictly speaking, the file is an archive of files, i.e., a zip file, with a particular structure and content that adheres to the specifications for an R package. More specifically, the method 150 quantifies the consensus phenotype similarity to described disorders in a gene's signaling neighborhood. An aim of the method is to assess the likelihood that a gene variant causes an observed rare disease, by quantifying the consensus phenotype similarity to described disorders in the gene's signaling neighborhood.

A first step 152 includes accessing the trait-gene link data from trait-gene link data record 16, which was previously derived by processing the publicly accessible gene-disease link data and the publicly accessible disease-trait link data.

A second step 154, which may be performed before or after step 152, includes generating a query input section on a graphical user interface on a display of the computer configured for receiving inputs of human traits describing an input human phenotype 156 and an input of a candidate casual gene 158. In this embodiment, the input phenotype 156 is described by a plurality of input human traits in the form of HP terms of the HPO. The HP terms may be based on a phenotype exhibited by a patient with an undiagnosed condition, which may possibly be an unidentified rare Mendelian disease. For example, the patient may exhibit a phenotype that is described by the HP terms “Astigmatism” (HP:0000483), “Retinitis pigmentosa” (HP:0000510), “Cataract” (HP:0000518), “Nystagmus” (HP:0000639), “Intellectual disability” (HP:0001249), “Seizures” (HP:0001259), “Ventriculomegaly” (HP:0002119) and “Molar tooth sign on MRI” (HP:0002419).”

In order to identify one or more casual candidate genes, i.e., a gene that is a candidate for possibly describing the phenotype exhibited by the patient, all or some of the genome of the patient may be sequenced to identify genetic polymorphisms linked to gene function. In one preferred embodiment, only the exomes of the patient are sequenced. Also, if possible, the exomes of the parents of the patient are sequenced and compared with exomes of the patient to identify gene variants of the patient that may possibly be responsible for the patient's phenotype. Such a comparison may be especially helpful in identifying for example candidate genes for recessive or de novo genetic diseases. However, such a comparison is not necessary. The user may simply submit genes which the user believes may be genetically related to the phenotype.

In this example, the input candidate gene 158 is CC2D2A. CC2D2A is known to be the causal gene for Joubert Syndrome 9, a genetically heterogeneous group of disorders first described in 1969 and characterized by atrophy of the cerebellar vermis and malformation of the brain stem leading to physical, mental and sometimes visual impairment that can vary in severity. Although a known causal gene is used for exemplary purposes, the input candidate gene does not have to be a known casual gene in the present method, which allows the method to be used to identify previously unknown casual genes. For the Joubert Syndrome 9 example, which is continued below, the Joubert Syndrome 9 traits have been removed from the source data to produce this example. Basically, a known disease is rediscovered to demonstrate that the method works and that mechanistically related genes do produce a similar disease.

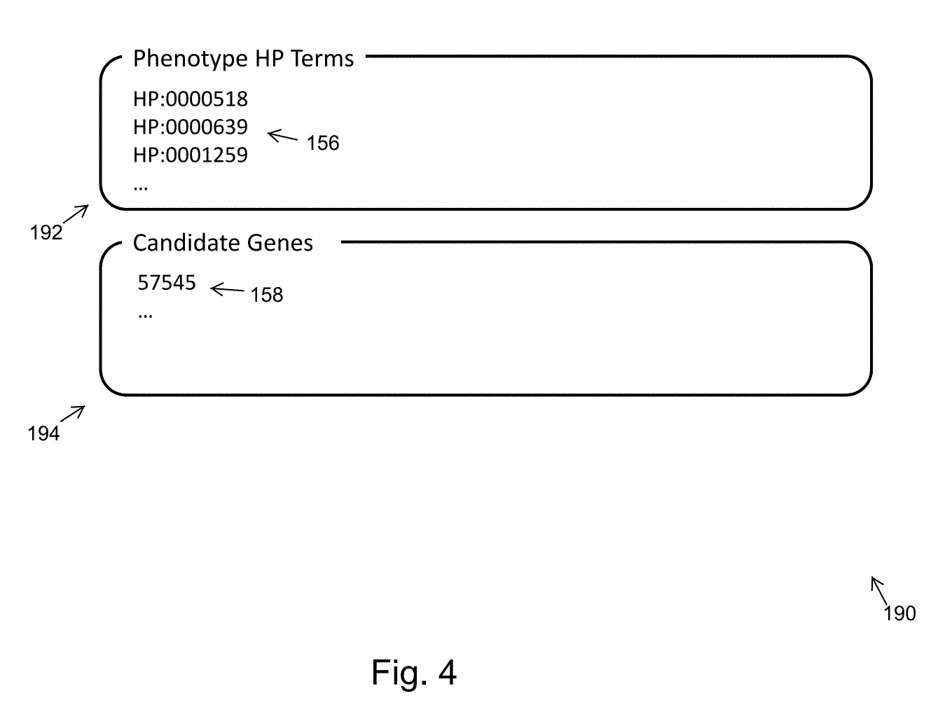

FIG. 4 shows an example of a graphical user interface 190 on a display of the computer including a phenotype input section 192 configured for receiving human trait inputs, which in this example are inputs HP terms, of a human phenotype input 156 and a candidate gene input section 194 configured for receiving an input of a candidate casual gene 158. As shown in FIG. 4, the HP terms may be entered by inputting the HPO ID numbers of the HP terms and the candidate casual gene may be entered by inputting the NCBI (National Center for Biotechnology Information) Gene IDs.

In embodiments where the computer readable media is an R-package, the full input commands for the phenotype and the candidate casual gene in the Joubert Syndrome 9 example would be for example:

```
hpOfInterest <- c(
  ″HP:0000483″,
  ″HP:0000510″,
  ″HP:0000518″,
  ″HP:0000639″,
  ″HP:0001249″,
  ″HP:0001259″,
  ″HP:0002119″,
  ″HP:0002419″,
)
geneOfInterest <- ″57545″.
```

Next, a step 160 includes accessing or calculating an information content (IC) for all the human traits, i.e., HP terms, in the data structure 14. In embodiments where IC is stored in IC data record 20, in response to the inputs in step 154, the computer readable medium instructs the processor to access the IC values for all HP terms as stored in IC data record 20.

Additionally or alternatively, the IC may also be calculated in response to a trait frequency input 162 and a trait descendants input 164 specified by the user. As noted above, the IC of a term is calculated as a function of the frequency of the trait, which is defined as the proportion of objects that are annotated by the term or any of its descendent traits. For trait frequency input 162, the user may input the trait frequencies in terms of either the genes or diseases linked to each HP term in data structure 14 by selecting or specifying the specific trait frequency to be used in the subsequent determinations. Additionally, the descendants of a HP term depend on the particular taxonomy specified. Accordingly, for trait descendants input 164 the user may input the trait descendants in terms of a particular taxonomy incorporating the traits, e.g., HP term, in data structure 14 by selecting or specifying the specific trait descendants to be used in the subsequent determinations. Processor 22 may then access equation (1) from data record 42 and performed IC calculations as a function of inputs 162, 164 to determine the IC values to populate IC data record 20.

Next, a step 166 includes calculating semantic similarity for each of the input traits of human phenotype input 156 in comparison to each of the traits stored in data structure 14. In other words, input HP terms are compared to each of the HP terms stored in data structure 14, such that all of the HP terms in data structure 14 are considered individually with respect to each individual HP term. In this embodiment, the similarity between two HP terms is calculated as the IC of their most informative common ancestor (MICA) in the HPO, in accordance with the MICA equation described in Resnik (1995) and Köhler et al., (2009). The MICA can be considered as the most specific HP term within the HPO taxonomy that the two compared HP terms descend from, i.e., the HP common ancestor that has the highest IC value. For such an approach, the more information the two topics share in common, the more similar they are. The semantic similarity calculation is performed in a manner similar to as in Köhler et al. (2009) to compare HP terms using the following equation (2):

$${SS}_{{HP}_{1} {HP}_{2}} = {IC}_{MICA} = - ln ( \frac{\vert MICA \vert}{\vert root \vert} ) \qquad ( 2 )$$

where:

SS_{HP1HP2} is the semantic similarity between a first HP term HP1 and a second HP term HP2; and

IC_{MICA} is the IC of the most informative common ancestor of the first HP term HP1 and the second HP term HP2;

|MICA| is the number of genes directly linked to the HP term that is the MICA or one of its descendants; and

root is a total number of genes in the trait-gene link data.

Processor 22 may access equation (2) from data record 42 and perform semantic similarity calculations as a function of inputs 162, 164 to determine the semantic similarity values to populate a trait-trait semantic similarity record 34. Specifically, for all of the input traits of human phenotype input 156 received in step 154, a trait-trait semantic similarity matrix may be stored in trait-trait semantic similarity record 34 including the semantic similarity values of for each individual input trait of human phenotype input 156 with respect to each of the human traits stored in data structure 14.

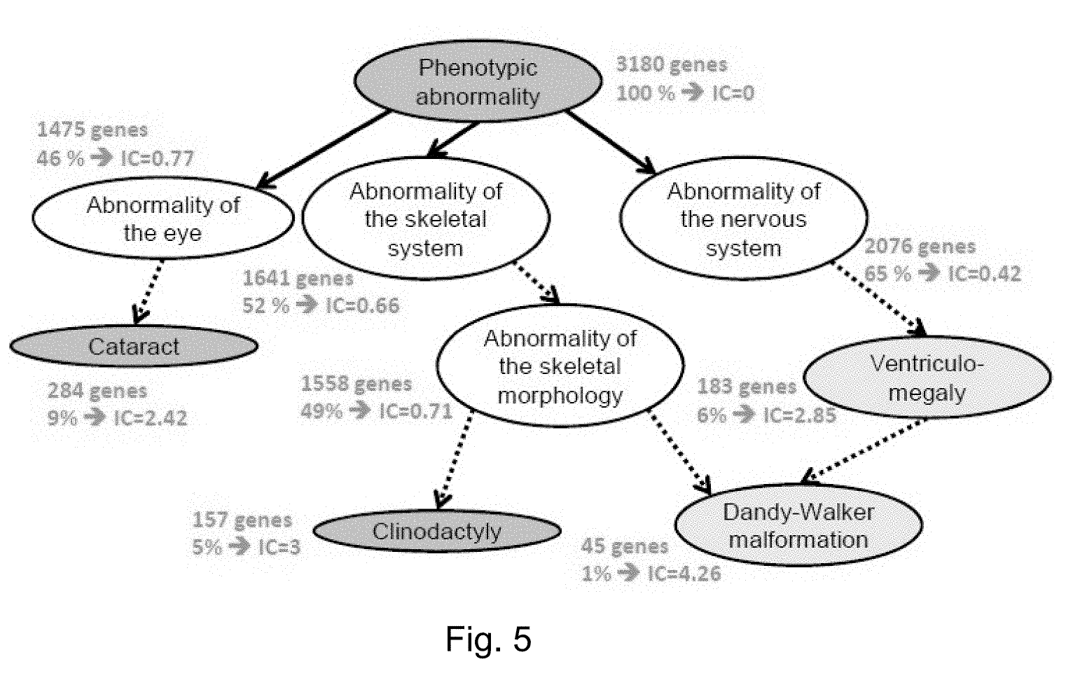

FIG. 5 illustrates a basic example of trait comparisons from the HPO including only nine HP terms. The IC for each HP term is shown adjacent to the icon of the HP term, along with the number and percentage of genes with which the HP term is linked. As similarly noted above, HP terms from higher levels of the ontology have a lower IC because they are linked with more genes, and thus are less specific. In contrast, the HP terms from lower levels of the ontology have a higher IC because they capture more specific traits and hence are linked with fewer genes. In this example, excluding “Phenotypic abnormality,” “Abnormality of the nervous system” is the least specific and has the lowest IC, while “Dandy-Walker malformation” is the most specific and has the highest IC. The two traits “Cataract” and “Clinodactyly” are very different and the only ancestor the two shared in common is “Phenotypic abnormality.” As “Phenotypic abnormality” has an IC of 0, the semantic similarity or IC_{MICA} of “Cataract” and “Clinodactyly” is 0. In contrast, to the other extreme, the two traits “Ventriculomegaly” and “Dandy-Walker malformation” are directly related, as “Dandy-Walker malformation” is a direct descendant of “Ventriculomegaly.” Accordingly, the MICA of these two terms is “Ventriculomegaly” and thus the semantic similarity or IC_{MICA} of “Ventriculomegaly” and “Dandy-Walker malformation” is ˜2.85, the IC of “Ventriculomegaly.” As an intermediate example, comparing “Clinodactyly” with “Dandy-Walker malformation”, the HP term that is their most informative common ancestor is “Abnormality of the skeletal system.” Accordingly, the semantic similarity score for “Clinodactyly” with respect to “Dandy-Walker malformation” is ˜0.71.

Next, a step 168 includes retrieving the semantic similarity of each input human trait of human phenotype input 156 to each human trait in data structure 14 that is linked to a disease-linked gene and populating a gene-specific trait-trait semantic similarity data record 36. In a preferred embodiment, gene-specific trait-trait semantic similarity data record 36 including a plurality of record sections, each record section being for a specific disease-linked gene.

In one embodiment, step 168 may first include querying trait-gene link data record 16 to identify each HP term that is linked to a gene known to be casually linked to a disease, i.e., a disease-linked gene. As noted above, the links between disease-linked genes and human traits are determined in step 102 and are stored in trait-gene link data record 16. Then, for each of these identified HP terms, the semantic similarity of each of the input HP terms with each of these identified HP terms are retrieved from the trait-trait semantic similarity matrix stored in trait-trait semantic similarity data record 34 and used to populate the respective record section of gene-specific trait-trait semantic similarity data record 36.

In another embodiment, each record section of gene-specific trait-trait semantic similarity data record 36 may be preassigned to a specific disease-linked gene and step 168 includes retrieving, for each of the HP terms linked to the respective disease-linked gene, the semantic similarity of each of the input HP terms with each of these identified HP terms are retrieved from the trait-trait semantic similarity matrix stored in trait-trait semantic similarity record 34 and are used to populate the respective record section of gene-specific trait-trait semantic similarity data record 36. Each record section of gene-specific trait-trait semantic similarity data record 36 may be in the form of a gene-specific trait-trait semantic similarity matrix storing the respective semantic similarity values.

Then, in a step 170, the symmetric semantic similarity of each of the disease-linked genes with respect to the input phenotype 156 is calculated and the calculated semantic similarity values are used to populate a gene-phenotype symmetric semantic similarity data record 38. Step 170 includes a first substep of calculating a semantic similarity value of each of the disease-linked genes with respect to each input human trait of input phenotype 156. In contrast to the semantic similarity values calculated in step 166, a single semantic similarity value is calculated for the similarity of the entire input phenotype to a respective disease-linked gene by considering all of the human traits, e.g., HP terms, of the input phenotype and all of the human traits, e.g., HP terms, linked to the respective disease-linked gene. The semantic similarity calculation is performed in a manner similar to as in Köhler et al. (2009) to compare two sets of HP terms—a first set of HP terms corresponding to the input phenotype and a second set of terms corresponding to a disease-linked gene—using the following equation (3):

$$sim ( Q \to D ) = \frac{{\sum }_{HP 1 ∈ Q} {max}_{HP 2 ∈ D} {SS}_{HP 1 , HP 2}}{\vert Q \vert} \qquad ( 3 )$$

where:

Q is the input (i.e., query) traits corresponding to the phenotype of interest;

D is the traits for diseases linked to the respective disease-linked gene; and

|Q| is the number of HP terms describing the input phenotype.

Alternative methods may be employed for comparing HP terms sets such as after Pandey et al (https://bioinformatics.oxfordjournals.org/content/24/16/i28.full) which defines the similarity between two term sets as the information content of the set of minimum common ancestors.

Accordingly, the semantic similarity values calculated in step 166 using equation (2) are used to calculate the semantic similarity value for entire input phenotype to a respective disease-linked gene. Processor 22 may access equation (3) from data record 42 and the semantic similarity values from gene-specific trait-trait semantic similarity data record 36 to calculate the semantic similarity values for entire input phenotype to a respective disease-linked gene. For each of the HP terms describing the input phenotype, the “best match” among the corresponding disease-linked gene HP terms is found and the average over all of the query HP terms is calculated. In other words, for each input HP term, the semantic similarity, here the MICA, is determined for each of the HP terms of the respective disease-linked gene. The “best match” is the maximum semantic similarity value for an input HP term and the HP terms of the respective disease-linked gene.

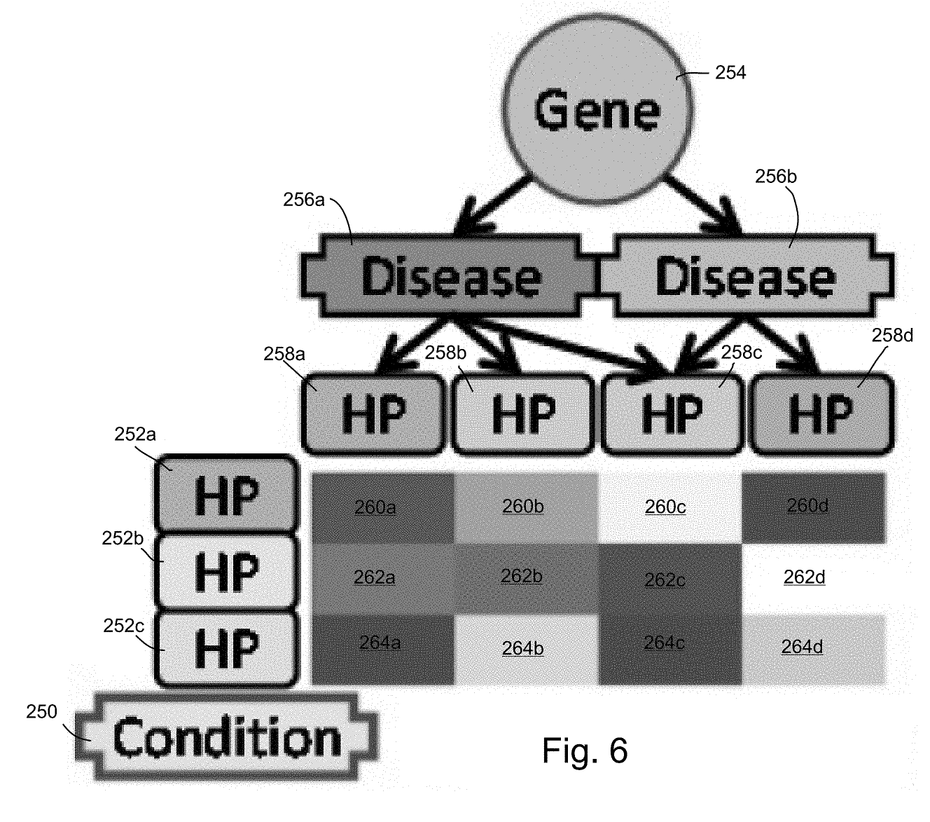

FIG. 6 illustrates a basic example of a visualization of a comparison of a phenotype or condition 250 consisting of three human traits—HP terms 252a, 252b, 252c—and a gene 254 known to cause two different diseases 256a, 256b that together are linked with four human traits—HP terms 258a, 258b, 258c, 258d. A semantic similarity is calculated for each HP term 252a, 252b, 252c with respect to each HP term 258a, 258b, 258c, 258d using equation (2) as described in step 166 and these semantic similarity values are displayed in a graph, in which HP term 252a, 252b, 252c are on the y-axis and HP term 258a, 258b, 258c, 258d are on the x-axis, as boxes 260a to 264d, with each box 260a to 264d illustrating one of the semantic similarity values. In this embodiment, the graph is a heat map and boxes 260a to 264d are shaded based on the magnitude of the semantic similarity values, with the darkest boxes having the highest values and the lightest boxes having the lowest values. For example, a box 260a relates to a semantic similarity of HP terms 252a and 258a, a box 260b relates to a semantic similarity of HP terms 252a, 258b, a box 260c relates to a semantic similarity of HP terms 252a, 258c and a box 260d relates to a semantic similarity of HP terms 252a, 258d. Similarly, boxes 262a to 262d llustrate sematic similarities of HP term 252b with respect to HP terms 258a to 258d, respectively, and boxes 264a to 264d illustrate sematic similarities of HP term 252c with respect to HP terms 258a to 258d, respectively.

For HP term 252a and gene 254, the “best match” is the highest of semantic similarity values 260a, 260b, 260c and 260d. As scores 260a and 260d are both of the same darkness, for this example it will be assumed that 260a is the highest value, and thus HP term 258a is the “best match” for HP term 252a of the HP terms 258a to 258d of gene 254. For HP term 252b, the semantic similarity value 262c is the highest value (i.e., the corresponding block is darker than the blocks for values 262a, 262b and 262d) and thus HP term 258c is the “best match” for HP term 252b of the HP terms 258a to 258d of gene 254. For HP term 252c, as scores 264a and 264c are both of the same darkness, for this example it will be assumed that 264c is the highest value, and thus HP term 258c is the “best match” for HP term 252c of the HP terms 258a to 258d of gene 254. Then, the best matches for each HP term 252a, 252b, 252c are added together and divided by the number of HP terms 252a, 252b, 252c. Accordingly, the semantic similarity value of phenotype 250 to gene 254 is the average of scores 260a, 262c and 264c.

A second substep of step 170, which may be performed simultaneous to, before or after the first substep, includes calculating a semantic similarity value of the disease-linked genes to the input phenotype, which is essentially the reverse of the calculation in the first substep of step 170. The semantic similarity calculation is performed to compare a first set of HP terms corresponding to a disease-linked gene and a second set of terms corresponding to the input phenotype—using the following equation (4):

$$sim ( D \to Q ) = \frac{{\sum }_{HP 1 ∈ D} {max}_{HP 2 ∈ Q} {SS}_{HP 1 , HP 2}}{\vert D \vert} \qquad ( 4 )$$

where:

|D| is the number of HP terms describing the respective disease-linked gene. Accordingly, the semantic similarity values calculated in step 166 using equation (2) are used to calculate the semantic similarity value for entire input phenotype to a respective disease-linked gene. Processor 22 may access equation (4) from data record 42 and the semantic similarity values from gene-specific trait-trait semantic similarity data record 36 to calculate the semantic similarity values for entire input phenotype to a respective disease-linked gene. For each of the HP terms linked to the respective disease-linked gene, the “best match” among the HP terms describing the input phenotype is found and the average over all of the HP terms linked to the respective disease-linked gene is calculated. In other words, for each HP term linked to the respective disease-linked gene, the semantic similarity, here the MICA, is determined for each of the input HP terms. The “best match” is the maximum semantic similarity value for an HP term of the respective disease-linked gene to the input HP terms.

For example, referring back to FIG. 6, the best match for HP term 258a and phenotype 250 is the highest of semantic similarity values 260a, 262a and 264a. As scores 260a and 264a are both of the same darkness, for this example it will be assumed that score 260a is the highest value, and thus HP term 252c is the “best match” for HP term 258a of the HP terms 252a to 252c of phenotype 250. For HP term 258b, the semantic similarity value 262b is the highest value (i.e., the corresponding block is darker than the blocks for values 260b and 264b) and thus HP term 252b is the “best match” for HP term 258b of the HP terms 252a to 252c of phenotype 250. For HP term 258c, as scores 262c and 264c are both of the same darkness, for this example it will be assumed that 264c is the highest value, and thus HP term 252c is the “best match” for HP term 258c of the HP terms 252a to 252c of phenotype 250. For HP term 258d, the semantic similarity value 260d is the highest value and thus HP term 252a is the “best match” for HP term 258d of the HP terms 252a to 252c of phenotype 250. Then, the best matches for each HP term 258a, 258b, 258c, 258d are added together and divided by the number of HP terms 258a, 258b, 258c, 258d. Accordingly, the semantic similarity value of gene 254 to phenotype 250 is the average of scores 260a, 262b, 264c and 260d.

Then, after the first two substeps, step 170 further includes a substep of calculating a symmetric semantic similarity value of the input phenotype with respect to each of the disease-linked genes using the calculations performed in the first two substeps of step 170 using equations (3) and (4). The symmetric semantic similarity value of the input phenotype with respect to each of the disease-linked genes is calculated by taking the average of the semantic similarity value of the input phenotype to the respective candidate gene traits and the semantic similarity value of the respective candidate gene traits to the input phenotype—using the following equation (5):

$$( D , Q ) = \frac{sim ( D \to Q ) + sim ( Q \to D )}{2} . \qquad ( 5 )$$

Processor 22 may access equation (5) from data record 42 and perform semantic similarity calculations as a function of the semantic similarity values calculated using equations (3) and (4) to determine the symmetric semantic similarity value of the input phenotype with respect to each of the disease-linked genes to populate a phenotype-gene symmetric semantic similarity matrix in gene-phenotype symmetric semantic similarity data record 38.

Accordingly, step 170 involves, for each trait describing the input phenotype that the best match among gene HP terms (D) is identified for each of the disease-linked genes and the average of the best match scores for all the input HP terms for each gene is computed. The same calculus is applied with gene HP terms compared to input HP terms for each gene. The symmetric semantic similarity is the average of these two scores.

Next, a step 172 includes searching, in response to the input candidate gene 158, mechanistically related genes data and identifying which of the disease-linked genes are mechanistically related to the input candidate gene 158. As noted above, in the preferred embodiment, step 172 may include searching the mechanistically related genes data stored in mechanistically related genes data record 18 of data structure 14, which may include information from the Reactome and/or MetaBase databases (i.e., biological pathway data 174), and identifying disease-linked genes implicated in common molecular mechanisms (i.e., in the same pathways) as the candidate gene and/or searching the STRING database and/or MetaBase database (biological network data 176) and identifying disease-linked genes that encode protein products that are interaction partners of the encoded protein product of the gene of interest (i.e., in the same networks). In this example, CC2D2A encodes a coiled-coil and calcium domain binding protein that belongs to the “Anchoring of the basal body to the plasma membrane” Reactome pathway; a process involved in the assembly of the primary cilium. Of the 88 mechanistically related genes in the “Anchoring of the basal body to the plasma membrane” Reactome pathway, 39 of the mechanistically related genes are known to be casually linked to Mendelian diseases as determined by searching the data in the clinVar database.

The identified disease-linked mechanistically related genes may then be stored as a identified gene set in a identified gene set data record in data structure 14. The identified gene set may include the input candidate gene only if the input candidate gene is a disease-linked gene. If the input candidate gene is not a disease-linked gene, it is not included in the identified gene set and it is not relevant for the semantic similarity calculations of steps 180, 182, as the input candidate gene is therefore not linked to human traits per the trait-gene data. An advantage of the embodiments of the present invention is that a candidate gene that is not currently known to be disease-linked may be analyzed with respect to a phenotype based on the mechanistically related genes. In this example, as the candidate gene CC2D2A is known to be disease-linked, the candidate gene is included in the further analysis of steps 180, 182.

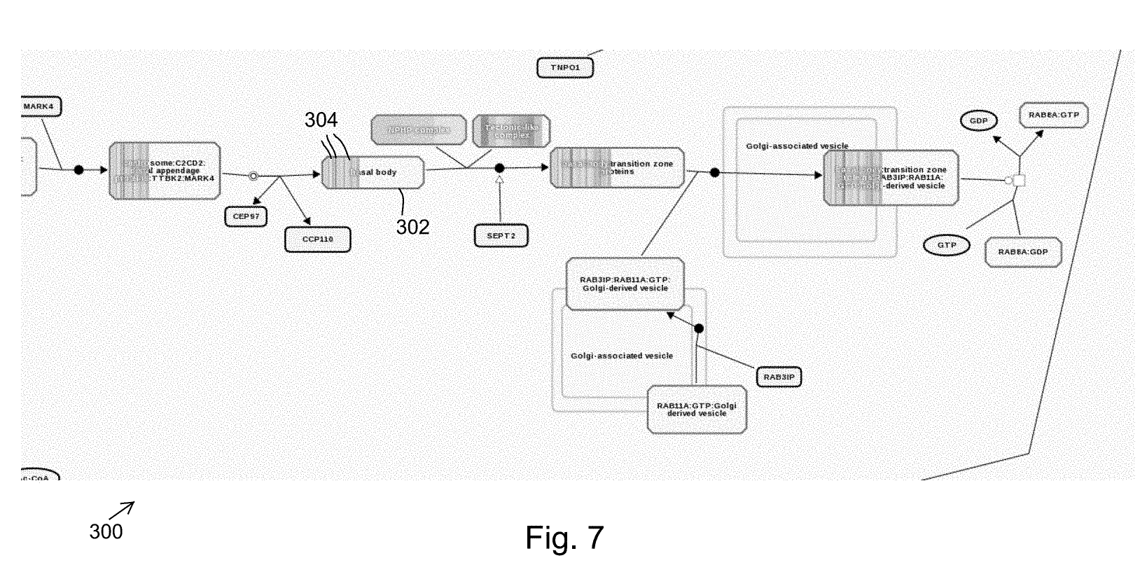

FIG. 7 shows an example mechanistic links visualization 300 illustrating a plurality of Reactome pathways including the “Anchoring of the basal body to the plasma membrane” Reactome pathway, which is represented by an icon 302. Icon 302 represents the entire pathway and is overlaid with a plurality of bars 304. Each bar 304 represents the symmetric semantic similarity of one of the genes active—i.e., a gene whose encoded proteins performs a function—in the “Anchoring of the basal body to the plasma membrane” Reactome pathway and that is known to cause a rare human genetic disease, with respect to the input phenotype. Each bar 304 has a color that corresponds to the symmetric semantic similarity value. A user may review more information regarding each bar 304 by hovering the mouse cursor over the bar 304 or by selecting the bar 304 via a mouse click or touchscreen touch.

Additionally or alternatively, the mechanistically related genes data may be specified by the user via the selection of one of more sources of biological pathway data 174 and/or biological network data 176 to be used in step 172, or the user may upload specific biological pathway data 174 and/or biological network data 176 to populating of mechanistically related genes data record 18.

Next, a step 178 includes retrieving the respective symmetric semantic similarity values of the input phenotype with respect to each of the disease-linked genes from phenotype-gene symmetric semantic similarity record 38. This retrieving includes retrieving the respective symmetric semantic similarity values of the input phenotype with respect to the genes of the identified gene set.

In other embodiments of the invention, method 150 may include slightly different steps than steps 152, 154, 160, 166, 168, 170, 172, 178 or these steps may be performed in a different order. For example, method 150 may include steps of accessing disease-gene link data or accessing mechanistically linked genes data after or simultaneous to step 152 and before step 154. Also, the mechanistically linked genes data may be searched directly after step 154 to identifying genes that are mechanistically related to the input candidate gene, then disease-gene link data may be searched to determine which of the mechanistically related genes are known to disease-linked and to determine if the candidate gene is disease-linked to define an identified gene set. Next, the trait-gene link data may be searched to identify human traits linked with the identified gene set. Then, the IC for each of human traits in the trait-gene database is calculated, each of the input HP terms are compared to each of the HP terms linked with the candidate gene and each of the HP terms linked with each of the related genes to determine the semantic similarity of the input HP term to each of the HP terms and then the symmetric semantic similarity value of the input phenotype with respect to genes of the identified gene set are determined; and the symmetric semantic similarity values may also be calculated for the input phenotype with respect to each of the other known disease genes, i.e., all known disease genes other than those in the identified gene set.

After step 178, method 150 includes a step 180 includes comparing the symmetric semantic similarity values of the genes of the identified gene set with respect to the input phenotype with the symmetric semantic similarity values of each of the other disease-linked genes identified in step 172 with respect the input phenotype as to determine whether the symmetric semantic similarity values for candidate-related genes are, as a population, greater than the values for all other disease-linked genes using a Mann-Whitney U Test to assess statistical significance against a p-value threshold of 0.05. Alternative methods for assessing statistical significance can be used, including resampling to empirically generate the sampling distribution of the symmetric semantic similarity test statistic. For example, this may include randomly generating a set of mechanistically related, disease-linked genes of the same size as the disease-linked genes in the actual pathway of the candidate gene from a gene pathway database. Then, symmetric semantic similarity scores may be recalculated for each resampled, mechanistically related gene set and compared to the equivalent values of the actual pathway of the candidate gene. This comparison will produce a semantic similarity test statistic. If the test statistic of the actual pathway is greater than 95% of the resampled test statistics then that result may be reported as being statistically significant. A statistical measure indicating whether the values of the semantic similarity metric of the genes of the identified gene set with respect to the input phenotype are greater than the values of the semantic similarity metric of others of the identified disease-linked genes with respect to the input phenotype by a statistically significant amount is output on one of the respective display 30 or 32. In a preferred embodiment, step 180 involves applying a one-sided Mann-Whitney U test to determine if the symmetric semantic similarity scores of the genes of the identified gene set tend to be greater than all other of the identified disease linked-genes by a statistically significant amount.

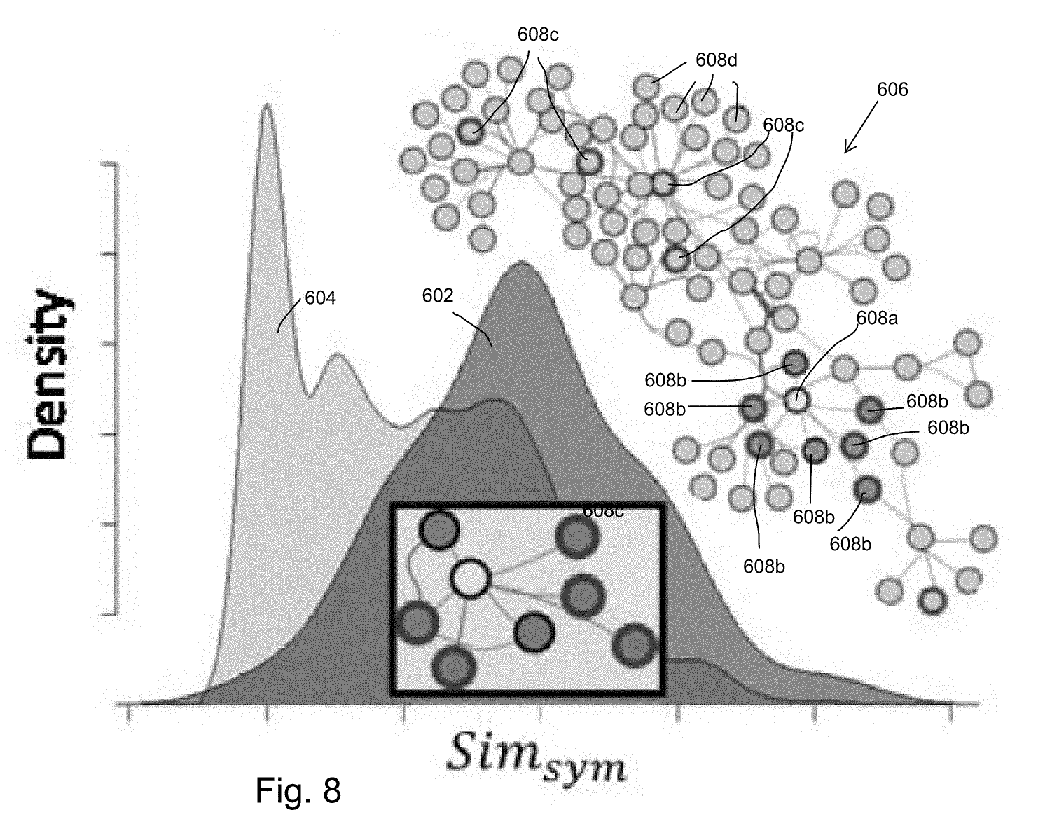

Next, a step 182 includes generating a visualization of results of the Mann-Whitney U test on the graphical user interface as shown in FIG. 8. The visualization may be generated by retrieving the symmetric semantic similarity value of the input phenotype with respect to each of the disease-linked genes from gene-phenotype symmetric semantic similarity data record 38, and populating a corresponding Mann-Whitney U graph database in graph database record 40. The data in the graph database record 40 may then be used to generate the visualization shown in FIG. 8. The visualization includes a graph plotting the density of the symmetric similarity scores. A first curve 602 illustrates the density of the symmetric similarity scores for the genes of the identified gene set and a second curve 604 illustrates the density of the symmetric similarity scores for the all other disease linked-genes. For purposes of explanation, the two density distributions can be conceived as derived from a biological network representation 606 showing all of the genes in a biological network of the candidate gene, which is based on data of one or more of the biological network databases (e.g., STRING database and Metabase). The biological network includes genes represented by nodes 608a, 608b, 608c, 608d and links 610 between the nodes 608a, 608b, 608c, 608d. The nodes 608b, 608c highlighted by a thicker outline represent disease-linked genes. A node 608a represents the candidate gene, a plurality of nodes 608b directly linked to the candidate gene represent the genes mechanistically related to the candidate gene, a plurality nodes 608c represent disease-linked genes that are not mechanistically related to the candidate gene and the remaining nodes 608d represent genes that are not mechanistically related to the candidate gene that are not known to be disease linked.

In addition to the visualization shown in FIG. 8, step 182 may include generating one or more further visualizations on the display of the local or remote computer. The visualizations may include a the visualization illustrated in FIG. 6 and/or visualization illustrating mechanistic links between the candidate gene and the related genes on the graphical user interface on the display of the computer, such as the one shown in FIG. 7. The mechanistic links visualization may include one or more pathways in which the candidate gene is implicated and/or the arrangement of the genes that encode protein products that are interaction partners of the encoded protein product of the gene of interest. The mechanistic links visualization may illustrate all of the mechanistically related genes and highlight the disease-linked mechanistically related genes or may only illustrate the disease-linked mechanistically related genes. Alternate visualization such as radial plot are also possible.

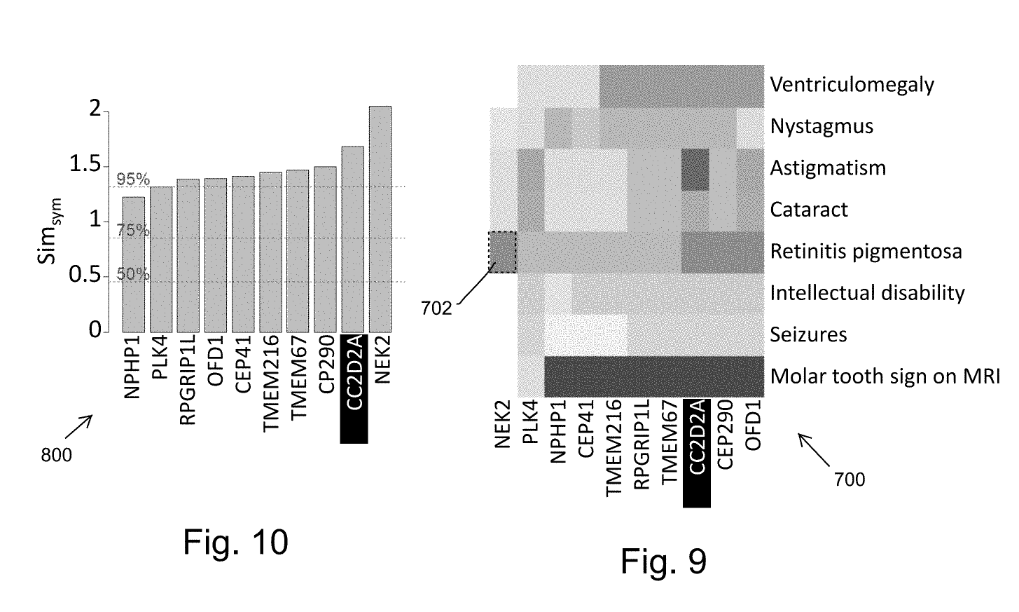

FIG. 9 further illustrates another visualization 700 that may be generated in step 182 by the computer program product on the graphical user interface to provide semantic similarity information to a user. In this visualization 700, the input HP terms are provided on the y-axis and the candidate gene CC2D2A and nine genes mechanistically related to CC2D2A and having the highest semantic similarity values with respect to CC2D2A are shown on the y-axis. Semantic similarity values of the candidate gene and each of the related genes to each of the input HP terms are calculated and displayed in boxes that are shaded based on the magnitude of the semantic similarity values, with the darkest boxes having the highest values and the lightest boxes having the lowest values. For example, the HP terms linked with the gene NEK2 are each compared to the input HP term “Retinitis pigmentosa” and the semantic similarity to “Retinitis pigmentosa” is calculated for each HP term linked with the gene NEK2. Then, the best match the calculated semantic similarity values, i.e., the highest value, is determined to be the semantic similarity value of gene NEK2 for “Retinitis pigmentosa.” This calculated is repeated for each gene with respect to each input HP term. After these calculations are completed, the values are then displayed based on the quantile of each semantic similarity value in comparison with the other values of this data set. For example, a box 702 represents the magnitude of the semantic similarity value of gene NEK2 for “Retinitis pigmentosa.” Visualization 700 enables a user to identify HP terms that are contributing highly to the observed symmetric semantic similarity for a gene and the gene-linked HPs. Visualization 700 is particularly useful when considering mechanistically related genes, as certain traits may be caused by particular signaling interactions for multi-functional genes.

FIG. 10 further illustrates another visualization 800 that may be generated by the computer program product on the graphical user interface to provide semantic similarity information to a user. Visualization 800 is a bar graph illustrating the symmetric semantic similarity values for a different set of genes and HP terms, with dotted lines representing the quantiles of the symmetric similarity values for all disease linked genes with respect to the input phenotype. FIG. 10 illustrates how genes belonging to the same pathway and hence mechanism as the causal gene for Joubert Syndrome 9; CC2D2A cause similar diseases to Joubert syndrome As shown, a gene NEK2 has a symmetric semantic similarity value of over 2, which appears to be the highest value of all of the symmetric semantic similarity values, as it extends well past the Q95%.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A computer program product, disposed on a non-transitory computer readable media, for analyzing a biological relevance of a candidate gene to a human phenotype, the product including computer executable process steps operable to control a computer to:
receive an input phenotype comprised of a plurality of input human traits and at least one input candidate gene;
identify a plurality of disease-linked genes by querying disease-linked gene data and identifying genes causally linked to at least one disease;
provide values of a semantic similarity metric for a identified gene set with respect to the input phenotype based on a comparison of human traits linked to each gene of the identified gene set and the input human traits, the identified gene set including genes mechanistically related to the input candidate gene that are included in the identified disease-linked genes; and
output a statistical measure indicating whether the values of the semantic similarity metric of the genes of the identified gene set with respect to the input phenotype are greater than the values of the semantic similarity metric of others of the identified disease-linked genes with respect to the input phenotype by a statistically significant amount.

2. The computer program product as recited in claim 1 wherein the identified gene set includes the input candidate gene only if the input candidate gene is included in the identified disease-linked genes.

3. The computer program product as recited in claim 1 wherein the statistical measure is a result of a one-sided Mann-Whitney U test or a resampling operation.

4. The computer program product as recited in claim 1 wherein the step of outputting a statistical measure includes performing a one-sided Mann-Whitney U test to the values of the semantic similarity metric of the genes of the identified gene set with respect to the input phenotype in comparison to the values of the semantic similarity metric of others of the identified disease-linked genes with respect to the input phenotype.

5. The computer program product of claim 1 wherein the step of outputting a statistical measure includes generating a visualization illustrating the values of the semantic similarity metric of the genes of the identified gene set in comparison to the values of the semantic similarity metric of others of the identified disease-linked genes to demonstrate a significance of the candidate gene with respect to the input phenotype.

6. The computer program product as recited in claim 5 wherein the step of outputting a statistical measure includes performing a one-sided Mann-Whitney U test to the values of the semantic similarity metric of the genes of the identified gene set with respect to the input phenotype in comparison to the values of the semantic similarity metric of others of the identified disease-linked genes with respect to the input phenotype.

7. The computer program product as recited in claim 1 wherein the semantic similarity metric is symmetric semantic similarity.

8. The computer program product of claim 7 including the additional process step of generating a visualization including a graph of the symmetric semantic similarity values of the input phenotype with respect to genes of the identified gene set.

9. The computer program product as recited in claim 7 wherein the providing the symmetric semantic similarity values for the genes of the identified gene set with respect to the input phenotype includes generating semantic similarity values for the input phenotype to the genes of the identified gene set.

10. The computer program product as recited in claim 9 wherein the providing the symmetric semantic similarity values for the genes of the identified gene set with respect to the input phenotype includes further generating semantic similarity values for the genes of the identified gene set to the input phenotype, the symmetric semantic similarity values being an average of the semantic similarity values for the input phenotype to the genes of the identified gene set and the semantic similarity values for the genes of the identified gene set to the input phenotype.

11. The computer program product as recited in claim 9 wherein the semantic similarity values of the input phenotype to the genes of the identified gene set is calculated using the following equation:
$$sim ( Q \to D ) = \frac{{\sum }_{HP 1 ∈ Q} {max}_{HP 2 ∈ D} {SS}_{HP 1 , HP 2}}{\vert Q \vert}$$
where:
SS_{HP1HP2} is the semantic similarity between a first human trait HP1 and a second human trait HP2;
Q is the input (i.e., query) traits corresponding to the phenotype of interest;
D is the traits for diseases linked to the respective disease-linked gene; and

|Q| is the number of HP terms describing the input phenotype.

12. The computer program product as recited in claim 9 wherein the generating the semantic similarity values for the input phenotype to the genes of the identified gene set includes generating semantic similarity values for each of the input human traits with respect to each of the human traits linked to each gene of the identified gene set.

13. The computer program product of claim 12 including the additional process step of generating a visualization including a graph of the semantic similarity values for each of the input human traits with respect to each of the human traits linked to each gene of the identified gene set.

14. The computer program product as recited in claim 12 wherein the semantic similarity values are calculated as an information content of a most informative common ancestor using the following equation:
$${SS}_{{HP}_{1} {HP}_{2}} = {IC}_{MICA} = - ln ( \frac{\vert MICA \vert}{\vert root \vert} )$$
where:
SS_{HP1HP2} is the semantic similarity between a first human trait HP1 and a second human trait HP2; and
IC_{MICA} is the IC of the most informative common ancestor of the first human trait HP1 and the second human trait HP2;

|MICA| is the number of genes directly linked to or descendants of the most informative common ancestor of the first human trait HP1 and the second human trait HP2; and
root is a total number of genes in the trait-gene link data.

15. The computer program product as recited in claim 12 wherein the generating semantic similarity values for each of the input human traits with respect to each of the human traits linked to each gene of the identified gene set includes calculating an information content for each of the input human traits and each of the human traits linked to each gene of the identified gene set.

16. The computer program product of claim 1 including the additional process step of providing a trait-gene link data record including trait-gene link data directly linking human traits to genes.

17. The computer program product of 16 wherein the providing values of the semantic similarity metric for the identified gene set with respect to the input phenotype based on the comparison of human traits linked to each gene of the identified gene set and the input human traits includes accessing the trait-gene link data record and retrieving the human traits linked to each gene of the identified gene set from the trait-gene data.

18. The computer program product of claim 1 including the additional process step of providing a mechanistically related genes data record including mechanistically related genes data for identifying the genes mechanistically related to the input candidate gene.

19. The computer program product as recited in claim 18 wherein the genes mechanistically related to the input candidate gene include genes implicated in common molecular mechanisms as the input candidate gene, the genes implicated in common molecular mechanisms as the input candidate gene being identified by searching a biological pathway database.

20. The computer program product as recited in claim 19 wherein the related genes that are mechanistically related to the input candidate gene include genes related in terms of protein interactions to the input candidate gene, the genes related in terms of protein interactions to the input candidate gene being identified by searching a biological network database.

21. The computer program product of claim 1 including the additional process step of generating a visualization illustrating mechanistic links between the input candidate gene and the genes mechanistically related to the candidate gene on a graphical user interface displaying calculated semantic similarity metric values in the context of the mechanistic links.

22. A method of delivering a file containing the computer program product recited in claim 1 comprising providing the file over the internet for download.

23. A computer implemented method for analyzing a biological relevance of a candidate gene to a human phenotype, the method being implemented on a computer including a processor and a memory, the method comprising:
receiving an input phenotype comprised of a plurality of input human traits and at least one input candidate gene;
identifying a plurality of disease-linked genes by querying disease-linked gene data and identifying genes causally linked to at least one disease;
providing values of a semantic similarity metric for a identified gene set with respect to the input phenotype based on a comparison of human traits linked to each gene of the identified gene set and the input human traits, the identified gene set including genes mechanistically related to the input candidate gene that are included in the identified disease-linked genes; and
outputting a statistical measure indicating whether the values of the semantic similarity metric of the genes of the identified gene set with respect to the input phenotype are greater than the values of the semantic similarity metric of others of the identified disease-linked genes with respect to the input phenotype by a statistically significant amount.

24. A computer configured for analyzing a biological relevance of a candidate gene to a human phenotype, the computer comprising:
a data structure including a trait-gene link data record and a mechanistically related genes data record, the trait-gene link data record including trait-gene link data directly linking human traits to genes, the mechanistically related genes data record including mechanistic links between genes; and
a processor configured to control the computer to:
receive an input phenotype comprised of a plurality of input human traits and at least one input candidate gene;
identify a plurality of disease-linked genes by querying disease-linked gene data and identifying genes causally linked to at least one disease;
provide values of a semantic similarity metric for a identified gene set with respect to the input phenotype based on a comparison of human traits linked to each gene of the identified gene set and the input human traits, the identified gene set including genes mechanistically related to the input candidate gene that are included in the identified disease-linked genes; and
output a statistical measure indicating whether the values of the semantic similarity metric of the genes of the identified gene set with respect to the input phenotype are greater than the values of the semantic similarity metric of others of the identified disease-linked genes with respect to the input phenotype by a statistically significant amount.
